(19) United States
(12) Patent Application Publication
(10) Pub. No.: US 2025/0336179 A1
(43) Pub. Date: Oct. 30, 2025

(54) INFORMATION PROCESSING DEVICE, INFORMATION PROCESSING SYSTEM, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Keita KATO, Tokyo (JP)

(21) Appl. No.: 19/186,971

(22) Filed: Apr. 23, 2025

(30) Foreign Application Priority Data
Apr. 30, 2024 (JP) 2024-074038

(51) Int. Cl. G06V 10/74; G06V 10/776

(52) U.S. Cl. CPC G06V 10/761; G06V 10/776

(57) ABSTRACT

An information processing device comprises a management unit configured to manage database information in which model information regarding a learned model is associated with at least one of a favorable item and an unfavorable item among processing targets processed by the learned model, the learned model being good at processing the favorable item and not good at processing the unfavorable item; and a generating unit configured to generate display control information for displaying the model information and information regarding at least one of the favorable item and the unfavorable item associated with the model information based on the database information.

### BACKGROUND OF THE INVENTION

### Field of the Invention

The present invention relates to an information processing device, an information processing system, an information processing method, and a non-transitory computer-readable storage medium.

### Description of the Related Art

In recent years, systems that use machine learning technologies are practically used in various fields. Not only companies and organizations create learned models used in such systems through machine learning but also general users can create such learned models for their intended uses, and accordingly, there are an enormous number of machine learning models.

Also, there are services that make created machine learning models open or available among general users via the Internet, and general users who use such a service need to select and obtain a model that is suitable for their intended use from an enormous number of learned models that are made open.

For example, Japanese Patent Laid-Open No. 2020-204970 proposes a method for assisting a user in selecting a learned model by displaying output of a plurality of learned models and determination results indicating success or failure in a table.

However, in the conventional technology disclosed in Japanese Patent Laid-Open No. 2020-204970 described above, only the output of the plurality of learned models and the determination results indicating success or failure are displayed in a table, and therefore, there is a problem in that it is difficult for the user to select a learned model suitable for their intended use from a large number of machine learning models that are made open.

### SUMMARY OF THE INVENTION

Under the above circumstances, the present invention provides an information processing device, an information processing system, an information processing method, and a non-transitory computer-readable storage medium that assist a user in selecting a learned model created through machine learning so that the user can easily select a learned model suitable for their intended use.

According to one aspect of the present disclosure, there is provided an information processing device comprising: a management unit configured to manage database information in which model information regarding a learned model is associated with at least one of a favorable item and an unfavorable item among processing targets processed by the learned model, the learned model being good at processing the favorable item and not good at processing the unfavorable item; and a generating unit configured to generate display control information for displaying the model information and information regarding at least one of the favorable item and the unfavorable item associated with the model information based on the database information.

According to another aspect of the present disclosure, there is provided an information processing system comprising: the information processing device above; a display unit configured to cause a display device to display at least one of the favorable item and the unfavorable item, and a list of the model information based on the display control information; and a model information obtaining unit configured to obtain the model information.

According to another aspect of the present disclosure, there is provided an information processing method comprising: managing database information in which model information regarding a learned model is associated with at least one of a favorable item and an unfavorable item among processing targets processed by the learned model, the learned model being good at processing the favorable item and not good at processing the unfavorable item; and generating display control information for displaying the model information and information regarding at least one of the favorable item and the unfavorable item associated with the model information based on the database information.

According to another aspect of the present disclosure, there is provided a non-transitory computer-readable storage medium storing a computer program that, when read and executed by a computer, causes the computer to function as: a management unit configured to manage database information in which model information regarding a learned model is associated with at least one of a favorable item and an unfavorable item among processing targets processed by the learned model, the learned model being good at processing the favorable item and not good at processing the unfavorable item; and a generating unit configured to generate display control information for displaying the model information and information regarding at least one of the favorable item and the unfavorable item associated with the model information based on the database information.

Further features of the present invention will become apparent from the following description of exemplary embodiments (with reference to the attached drawings).

### BRIEF DESCRIPTION OF THE DRAWINGS

FIG. 1 is a hardware configuration diagram of an information processing device of a server included in an information processing system according to an embodiment.

FIG. 2 is a hardware configuration diagram of an information processing device of a client included in the information processing system according to an embodiment.

FIG. 3 is a configuration diagram of the information processing system according to an embodiment.

FIG. 4 is a block diagram showing a configuration example of an information processing system according to a first embodiment.

FIG. 5 is a diagram showing a flowchart of a procedure of display processing for displaying a list of favorable images and unfavorable images associated with model information.

FIG. 6 is a diagram showing an example of database information for managing favorable images and unfavorable images in association with model information.

FIG. 7 is a diagram showing an example of display of a list of model information and favorable images and unfavorable images associated with the model information.

FIG. 8 is a diagram showing a flowchart of a procedure of model evaluation processing.

FIG. 9 is a block diagram showing a configuration example of an information processing system according to a second embodiment.

FIG. 10A is a diagram showing a flowchart of a procedure of display processing for displaying a list of model information associated with a favorable image that is a search instruction target, in a database.

FIG. 10B is a diagram showing a flowchart of a procedure of display processing for displaying a list of model information associated with a favorable image that is a search instruction target, in a database.

FIG. 11A is a diagram showing an example of database information for managing favorable images and unfavorable images in association with model information.

FIG. 11B is a diagram showing an example of database information of image capturing information.

FIG. 12 is a diagram showing an example of display of a list of favorable images.

FIG. 13 is a diagram showing an example of display of a list of model information.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

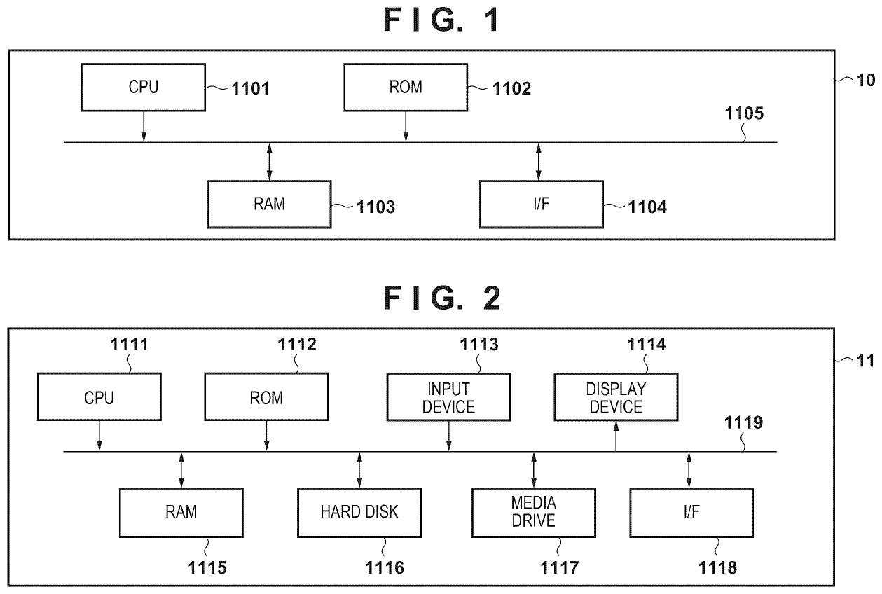

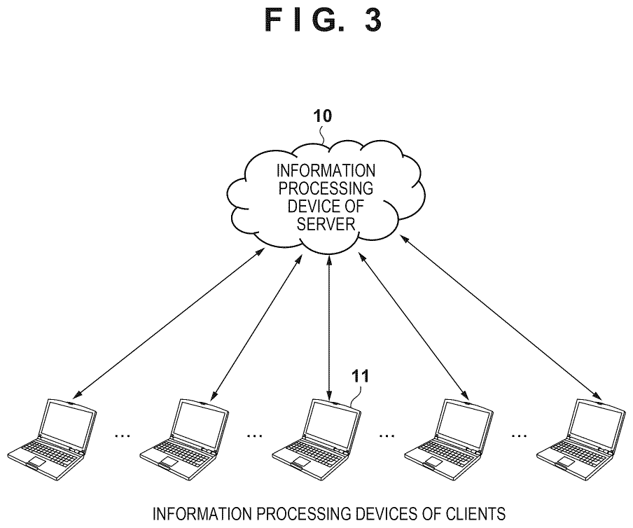

The following describes an information processing system according to an embodiment. The following describes hardware configurations of an information processing device of a server and an information processing device of a client included in the information processing system according to an embodiment with reference to FIGS. 1 and 2. Note that the server may also be a virtual server provided in a cloud or the like. The information processing devices are examples of a computer.

FIG. 1 is a hardware configuration diagram of an information processing device 10 of a server included in the information processing system according to an embodiment.

The information processing device 10 is realized by a cloud server, for example. The information processing device 10 includes a CPU 1101, a ROM 1102, a RAM 1103, an I/F 1104, and a system bus 1105. The CPU 1101, the ROM 1102, the RAM 1103, and the I/F 1104 are connected to each other via the system bus 1105 such that data can be transmitted and received therebetween.

The CPU 1101 is an abbreviation of Central Processing Unit, and is an arithmetic processing device. The CPU 1101 controls the ROM 1102, the RAM 1103, and the I/F 1104 connected to the system bus 1105, and various devices. The information processing device 10 may also include another processor such as an MPU (Micro Processing Unit), a GPU (Graphics Processing Unit), or a QPU (Quantum Processing Unit) instead of the CPU 1101 or in addition to the CPU 1101. Some or all functions of the information processing device 10 described below are realized by one or more processors including the CPU 1101 by reading a program stored in the ROM 1102 or the like, loading the program into the RAM 1103, and executing the program. Some or all functions of the information processing device 10 may also be realized by one or more circuits such as an ASIC (Application Specific Integrated Circuit) and a PLD (Programmable Logic Device) including an FPGA (Field Programmable Gate Array).

The ROM 1102 is an abbreviation of Read Only Memory, and is a non-volatile storage device. Various programs such as a BIOS (Basic Input/Output System) program and a boot program are stored in the ROM 1102. The information processing device 10 may also include a non-volatile storage device such as an HDD (Hard Disk Drive) or an SSD (Solid State Drive) in addition to the ROM 1102 or instead of the ROM 1102.

The RAM 1103 is an abbreviation of Random Access Memory. The RAM 1103 is a memory that allows high-speed data reading and writing and is used as a main storage device of the CPU 1101. For example, the RAM 1103 functions as a work area when the CPU 1101 executes a program.

The I/F 1104 functions as an interface for communication with external devices. For example, the I/F 1104 functions as a communication interface for communicating information via a network. The communication interface may use Ethernet (registered trademark), a USB, serial communication, wireless communication, or the like, and there is no particular limitation on the type of communication.

FIG. 2 is a hardware configuration diagram of an information processing device 11 of a client included in the information processing system according to an embodiment.

The information processing device 11 is a terminal device that is operated by a user and includes a screen to be viewed by the user. The information processing device 11 may be a PC (personal computer), a tablet terminal, or the like, for example. The information processing device 11 includes a CPU 1111, a ROM 1112, an input device 1113, a display device 1114, a RAM 1115, a hard disk 1116, a media drive 1117, an I/F 1118, and a system bus 1119. The CPU 1111, the ROM 1112, the input device 1113, the display device 1114, the RAM 1115, the hard disk 1116, the media drive 1117, and the I/F 1118 are connected to each other via the system bus 1119 such that data can be transmitted and received therebetween.

The CPU 1111 is an arithmetic processing device. The CPU 1111 controls the above-mentioned units from the ROM 1112 to the I/F 1118 connected to the system bus 1119, and various devices. The information processing device 11 may also include another processor such as an MPU, a GPU, or a QPU instead of the CPU 1111 or in addition to the CPU 1111. Some or all functions of the information processing device 11 described below are realized by one or more processors including the CPU 1111 by reading a program stored in the ROM 1112 or the hard disk 1116, loading the program into the RAM 1115, and executing the program. Some or all functions of the information processing device 11 may also be realized by one or more circuits such as an ASIC and a PLD including an FPGA.

The ROM 1112 is a non-volatile storage device. A BIOS (Basic Input Output System) program, a boot program, and the like are stored in the ROM 1112.

The input device 1113 accepts information or the like that is input by a user or the like. Examples of the input device 1113 include a touch panel, a keyboard, a mouse, and a robot controller.

The display device 1114 displays results of arithmetic operations performed by the information processing device 11, images transmitted from the information processing device 10 of the server, and the like in accordance with instructions from the CPU 1111. There is no particular limitation on the type of the display device 1114 as long as the display device is a device that displays images, information, and the like, such as a liquid crystal display device, a projector, or an LED indicator.

The RAM 1115 is a memory that allows high-speed data reading and writing and is used as a main storage device of the CPU 1111. For example, the RAM 1115 functions as a work area when the CPU 1111 executes a program.

The hard disk 1116 is, for example, a non-volatile storage device with a large capacity and is used as a storage. The hard disk 1116 stores, for example, an application, data such as image data, and a library. Data is read from or written into the hard disk 1116 based on instructions from the CPU 1111.

An attachable and detachable storage medium is connected to the media drive 1117. For example, the media drive 1117 writes data or the like stored in the hard disk 1116 into the connected storage medium. The media drive 1117 realizes data transfer to an external device such as a digital still camera, a computer such as a PC, or a tablet terminal by writing data into the storage medium.

The I/F 1118 is a communication interface and realizes information communication with external devices via a network. The I/F 1118 realizes, for example, information communication with the information processing device 10 of the server. The communication interface may use Ethernet, a USB (Universal Serial Bus), serial communication, wireless communication, or the like, and there is no particular limitation on the type of communication.

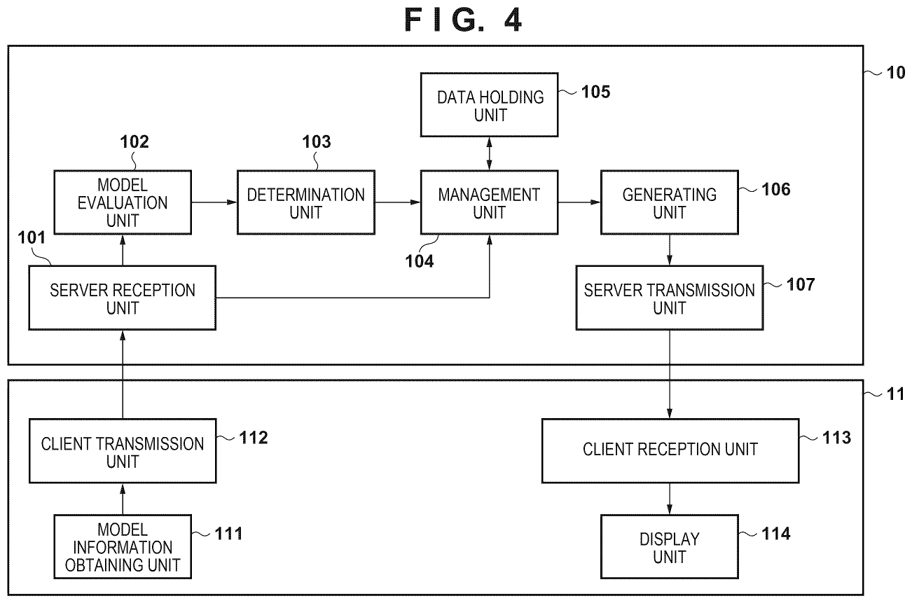

FIG. 3 is a configuration diagram of the information processing system according to an embodiment. The information processing system according to the present embodiment includes the information processing device 10 of the server and the information processing device 11 of the client. The information processing device 10 of the server communicates with information processing devices 11 of one or more clients to transmit and receive data and to control displayed information.

Terms used in the description of the present embodiment are defined as follows.

“Favorable image” is an example of a favorable item and is an evaluation image for which it is determined that detection accuracy is high when a learned model is used, among evaluation images included in evaluation data used to evaluate the learned model.

“Unfavorable image” is an example of an unfavorable item and is an evaluation image for which it is determined that detection accuracy is low when the learned model is used, among the evaluation images included in the evaluation data used to evaluate the learned model.

“Common evaluation data” is evaluation data that is commonly used for evaluation of all learned models managed by the information processing system according to the present embodiment. The common evaluation data includes evaluation images used for evaluation of each task and detection correct answer information associated with the evaluation images.

### First Embodiment

An information processing system according to a first embodiment assists a user in selecting a learned model by evaluating learned models created through machine learning in a cloud server and displaying favorable images and unfavorable images of the learned models created through machine learning, which are calculated from evaluation results, in association with model information in a terminal of a client. The following describes a case where a task handled in the present embodiment is an object detection task for detecting an object included in an image that is input to a model. The object detection task is a task for estimating a bounding box that surrounds a region of a specific object if an image whose data is input includes the specific object. However, the type of task that can be handled in the present embodiment is not limited to this example. The image is an example of a processing target that is processed by a learned model.

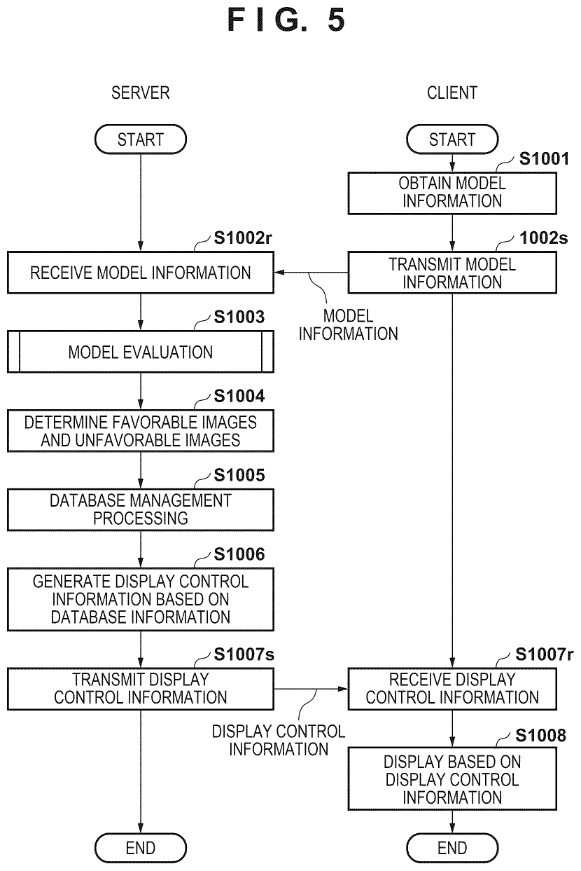

FIG. 4 is a block diagram showing an example of functions of the information processing system according to the first embodiment. FIG. 4 shows an example of the functional configuration, and does not limit the scope of application of the present embodiment. The information processing device 10 of the server includes a server reception unit 101, a model evaluation unit 102, a determination unit 103, a management unit 104, a data holding unit 105, a generating unit 106, and a server transmission unit 107. The information processing device 11 of the client includes a model information obtaining unit 111, a client transmission unit 112, a client reception unit 113, and a display unit 114.

Information is communicated via a network between the client transmission unit 112 and the server reception unit 101 and between the server transmission unit 107 and the client reception unit 113. The server transmission unit 107 and the client transmission unit 112 convert data into a format that is suitable for transmission and then transmit the data. The server reception unit 101 and the client reception unit 113 convert received data into a format that is suitable for use by a unit to which the data is output, and then output the data.

The server reception unit 101 receives information from the information processing device 11 of the client via the network. The server reception unit 101 receives, for example, model information of a learned model. The received model information is output to the model evaluation unit 102 and the management unit 104.

The model evaluation unit 102 receives the model information, evaluates the learned model indicated by the model information, and generates a model evaluation result. Details of the model evaluation are described below with reference to a flowchart showing a procedure of display processing for displaying a list of favorable images and unfavorable images associated with model information. The model evaluation unit 102 outputs the model evaluation result to the determination unit 103.

The determination unit 103 determines favorable images and unfavorable images based on the model evaluation result. Details of processing for determining the favorable images and the unfavorable images are described below with reference to the flowchart showing the procedure of the display processing for displaying a list of favorable images and unfavorable images associated with model information. The determination unit 103 outputs information of the determined favorable images and unfavorable images to the management unit 104.

The management unit 104 generates database information for managing the received model information in association with the determined favorable images and unfavorable images, and updates the database information. The management unit 104 outputs the model information, the favorable images, and the unfavorable images to the data holding unit 105 so that data of the images and the like included in the database information will be held as entities. The management unit 104 outputs the managed database information to the generating unit 106.

The data holding unit 105 receives the model information, the favorable images, and the unfavorable images from the management unit 104, and holds the received information and images based on the database information. The data holding unit 105 holds evaluation images prior to be determined as favorable images or unfavorable images through evaluation, and correct answer information of the evaluation images. Data held by the data holding unit 105, such as the model information, the favorable images, the unfavorable images, the evaluation images, and the correct answer information are used or deleted via the management unit 104 in the information processing device 10 of the server.

The generating unit 106 generates display control information for display in the information processing device 11 of the client based on the database information. The generating unit 106 outputs the generated display control information to the server transmission unit 107.

The server transmission unit 107 transmits the display control information received from the generating unit 106 to the client reception unit 113 of the information processing device 11 of the client via the network.

The model information obtaining unit 111 obtains model information of a learned model created through machine learning. The model information obtaining unit 111 outputs the obtained model information to the client transmission unit 112.

The client transmission unit 112 transmits the model information received from the model information obtaining unit 111 to the server reception unit 101 of the information processing device 10 of the server via the network.

The client reception unit 113 receives information from the information processing device 10 of the server via the network. The received information is the display control information. The received display control information is output to the display unit 114.

The display unit 114 displays images for the user based on the display control information received from the client reception unit 113. The display unit 114 displays the images using the display device 1114 capable of displaying images, such as a display monitor, a head-mounted display, a touch panel, or a projector.

Next, the following describes a processing procedure according to the present embodiment. In the following description, each step is denoted by a step number following S.

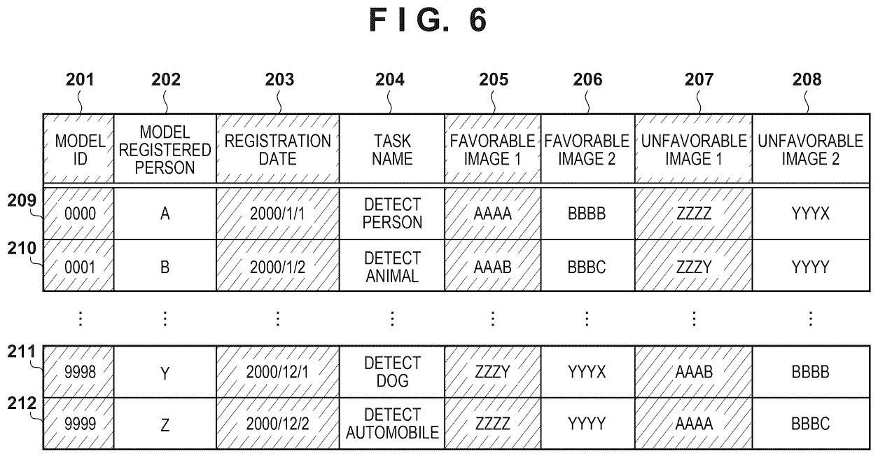

FIG. 5 is a diagram showing a flowchart of a procedure of display processing for displaying a list of favorable images and unfavorable images associated with model information, which is performed by the information processing system including the information processing device 11 of the client and the information processing device 10 of the server. The processing shown in the flowchart of FIG. 5 starts in response to model information that is an evaluation target being input to the information processing device 11 of the client, for example. However, the information processing system does not necessarily have to perform all steps shown in this flowchart, and the order of the steps may also be changed.

As preparation for executing the processing shown in the flowchart, the information processing device 11 of the client initializes the system. For example, the CPU 1111 reads a program from the ROM 1112 or the hard disk 1116 and makes the information processing device 11 ready to operate. In the information processing device 10 of the server, the CPU 1101 reads a program from the ROM 1102 and makes the information processing device 10 ready to operate. As a result, the information processing device 11 of the client and the information processing device 10 of the server enter a state where the information processing devices can communicate with each other using the client transmission unit 112, the server reception unit 101, the server transmission unit 107, and the client reception unit 113.

In step S1001, the model information obtaining unit 111 of the information processing device 11 of the client obtains model information registered in the hard disk 1116 or the like. The model information includes, for example, entity data such as parameters of a learned model, the name of a user who registered the model, the date on which the learned model was registered, and a task name indicating the name or type of task for which the learned model is used. However, the obtained model information is not limited to this example, and may also be entity data of the model and any information relating to the model. The model information obtaining unit 111 outputs the model information to the client transmission unit 112, and the processing proceeds to step S1002s.

In step S1002s, the client transmission unit 112 executes data conversion on the obtained model information. The client transmission unit 112 executes, for example, data conversion processing for compressing and encoding the model information into a format suitable for transmission. The client transmission unit 112 transmits the model information subjected to the data conversion to the server reception unit 101 of the information processing device 10 of the server.

In step S1002r, the server reception unit 101 of the information processing device 10 of the server performs data conversion processing on the received model information to decode and decompress the model information and convert the model information into the original format. The server reception unit 101 outputs the model information to the model evaluation unit 102 and the management unit 104, and the processing proceeds to step S1003.

In step S1003, the model evaluation unit 102 executes model evaluation processing using the model information received from the server reception unit 101 and common evaluation data. The model evaluation unit 102 calculates degrees of estimation reliability and estimation determination results of the learned model with respect to all evaluation images by executing the model evaluation processing. Details of the model evaluation processing will be described later. The model evaluation unit 102 outputs the obtained degrees of estimation reliability and estimation determination results of the learned model corresponding to all the evaluation images to the determination unit 103, and the processing proceeds to step S1004.

In step S1004, the determination unit 103 determines one or more favorable images and one or more unfavorable images among the evaluation images based on the degrees of estimation reliability and the estimation determination results corresponding to all the evaluation images, which have been received from the model evaluation unit 102. As a method for determining favorable images, the determination unit 103 extracts evaluation images for which it was determined that detection was successful based on the estimation determination results, and determines one or more favorable images from the extracted evaluation images in descending order of the degrees of estimation reliability. As a method for determining unfavorable images, the determination unit 103 extracts evaluation images for which it was determined that detection failed based on the estimation determination results, and determines one or more unfavorable images from the extracted images in ascending order of the degrees of estimation reliability. The determination unit 103 outputs information of the obtained one or more favorable images and one or more unfavorable images to the management unit 104, and the processing proceeds to step S1005.

In step S1005, the management unit 104 executes database management processing. For example, the management unit 104 receives the model information from the server reception unit 101 and receives the information of one or more favorable images and one or more unfavorable images from the determination unit 103. The management unit 104 generates or updates database information for managing the model information in association with the favorable images and the unfavorable images. The management unit 104 outputs entities of the model information, the favorable images, and the unfavorable images to the data holding unit 105 so that the model information, the favorable images, and the unfavorable images will be held based on the database information. The management unit 104 outputs the managed database information to the generating unit 106.

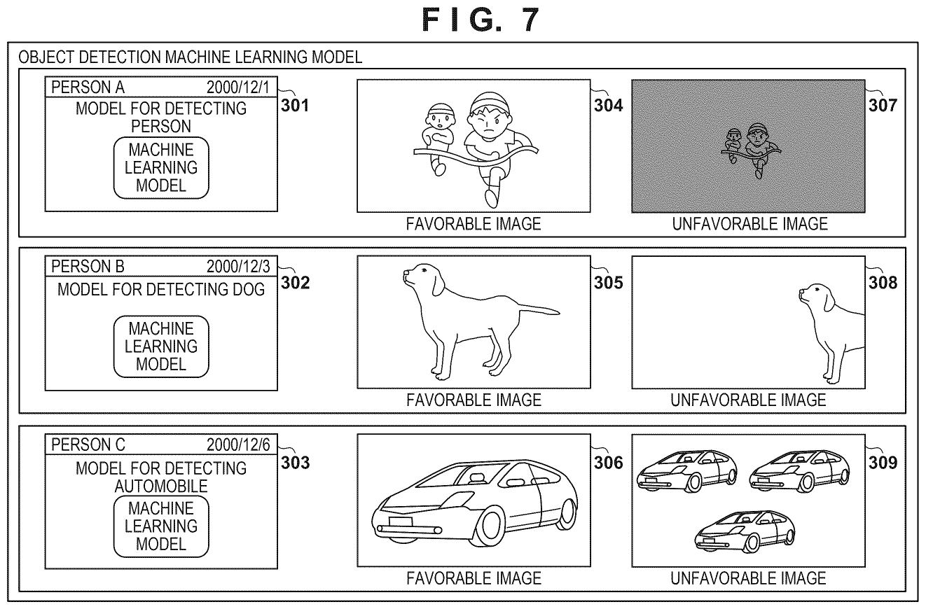

FIG. 6 is a diagram showing an example of the database information for managing favorable images and unfavorable images in association with model information. The following describes the database information with reference to FIG. 6.

Model ID 201 is identification information for identifying a registered learned model. The name of a user who input and registered the learned model in the model information obtaining unit 111 is held as a model registered person 202. The date on which the learned model was input and registered in the model information obtaining unit 111 is held as a registration date 203. The name or type of task for which the learned model input to the model information obtaining unit 111 is used is held as a task name 204.

File names of one or more favorable images determined in descending order of the detection accuracy (degrees of estimation reliability) from the one or more favorable images received from the determination unit 103 are held as favorable images 205 and 206. Although file names of two favorable images corresponding to the highest detection accuracy and the second highest detection accuracy are held as the favorable images 205 and 206 in this example, there is no limitation on the number of images to be held, and the number of file names of favorable images is not limited to that in this example.

File names of one or more unfavorable images determined in ascending order of the detection accuracy (degrees of estimation reliability) from the one or more unfavorable images received from the determination unit 103 are held as unfavorable images 207 and 208. Although file names of two unfavorable images corresponding to the lowest detection accuracy and the second lowest detection accuracy are held as the unfavorable images 207 and 208 in this example, there is no limitation on the number of images to be held, and the number of file names of unfavorable images is not limited to that in this example.

Model data 209 to 212 are examples of data relating to models managed in the database information. The model data 209 to 212 each include the model ID 201 and the data from the model registered person 202 to the unfavorable image 208, which are associated with the model ID 201.

In step S1006, the generating unit 106 obtains data that is necessary to display images by the display unit 114 based on the database information received from the management unit 104, and generates display control information. For example, the generating unit 106 extracts, from the database information, a plurality of pieces of model information held by the data holding unit 105 and data indicating, with respect to each piece of model information, one favorable image that is associated with the model information and for which it was determined that the detection accuracy is the highest and one unfavorable image that is associated with the model information and for which it was determined that the detection accuracy is the lowest, and obtains the extracted information and data together with data of the corresponding favorable image and the corresponding unfavorable image. Hereinafter, the obtained data will be referred to as “obtained data”. Based on the obtained data, the generating unit 106 generates display control information regarding display contents and display settings including each piece of model information, display positions of the favorable image and the unfavorable image associated with the model information, a window size, and a display text indicating contents of the model information and the like. However, the data obtained by the generating unit 106 and the display control information generated by the generating unit 106 are not limited to these types of information, and may also be any information that can be managed in the database information. The generating unit 106 outputs the obtained data and the generated display control information to the server transmission unit 107, and the processing proceeds to step S1007s.

In step S1007s, the server transmission unit 107 performs data conversion on the obtained data and the display control information received from the generating unit 106 by compressing and encoding the obtained data and the display control information, and then transmits the data and the information to the client reception unit 113 of the information processing device 11 of the client.

In step S1007r, the client reception unit 113 receives the obtained data and the display control information. The client reception unit 113 decodes and decompresses the received obtained data and display control information to convert the obtained data and the display control information into original formats. The client reception unit 113 outputs the obtained data and the display control information subjected to the data conversion to the display unit 114, and the processing proceeds to step S1008.

In step S1008, the display unit 114 causes the display device 1114 to display a list of the plurality of pieces of model information and favorable images and unfavorable images associated with the model information based on the obtained data and the display control information received from the client reception unit 113.

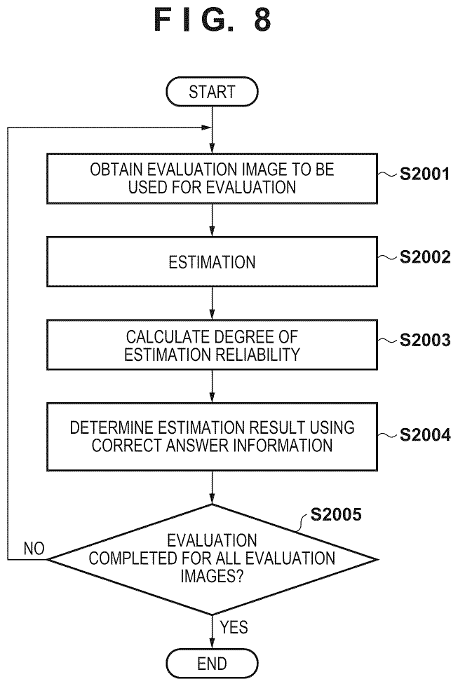

FIG. 7 shows an example of the displayed list of model information and favorable images and unfavorable images associated with the model information. The following describes the displayed list with reference to FIG. 7.

Model information 301 to 303 each show model information such as a task name of a task for which the corresponding model is used, a person who registered the model, and the date on which the model was registered.

Favorable images 304 to 306 each show an image that is associated with the corresponding model information and for which it was determined that the detection accuracy is the highest.

Unfavorable images 307 to 309 each show an image that is associated with the corresponding model information and for which it was determined that the detection accuracy is the lowest.

In this example, three pieces of model information are displayed and one favorable image and one unfavorable image are displayed with respect to each piece of model information in association with the model information, but there is no limitation on the numbers of pieces of model information, favorable images, and unfavorable images that are displayed, and display control regarding display positions of the model information, the favorable images, and the unfavorable images, and the form of the displayed images is not limited to that in the above-described example.

When the display unit 114 displays the list, the display processing ends.

Through the processing described above, it is possible to display a list of model information and favorable images and unfavorable images associated with the model information.

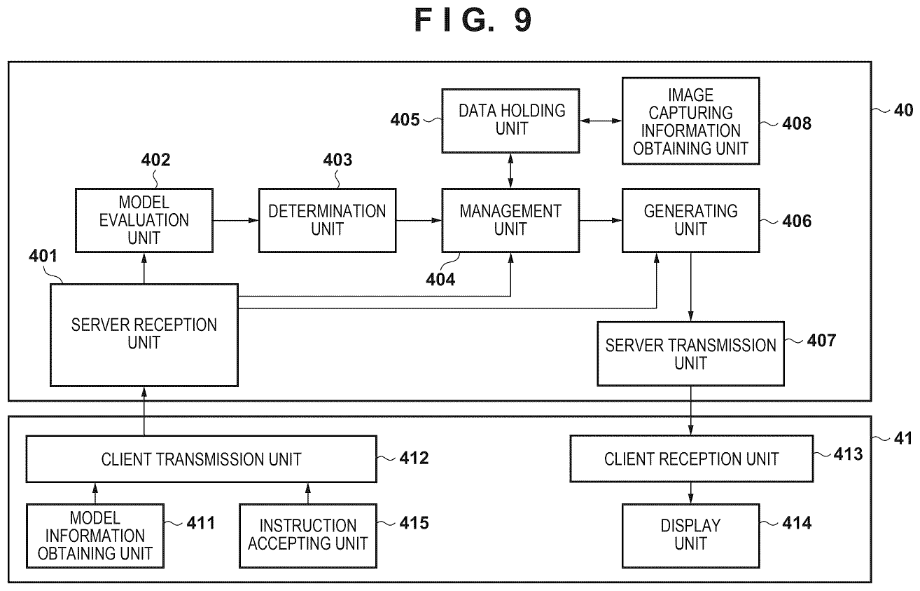

Next, the following describes details of the model evaluation processing performed in step S1003 with reference to FIG. 8. FIG. 8 is a diagram showing a flowchart of a procedure of the model evaluation processing.

In step S2001, the model evaluation unit 102 obtains an evaluation image to be used for the evaluation among a plurality of evaluation images included in the common evaluation data managed by the data holding unit 105 and correct answer information corresponding to the evaluation image. Note that the correct answer information referred to here is, for example, information that is defined by the user when supervised learning is performed in advance, and is a bounding box surrounding an object region that is to be detected in an input image in the object detection task. Although an example of the definition of the correct answer information is described, the definition of the correct answer information is not limited to this example. After obtaining the correct answer information, the model evaluation unit 102 proceeds to step S2002.

In step S2002, the model evaluation unit 102 executes estimation processing on the evaluation image to be used for the evaluation. A machine learning model such as a CNN (Convolutional Neural Network) or Transformers may be used for the estimation. By processing the evaluation image to be used for the evaluation with the model, a feature map, which is an intermediate output of the estimation processing, and an estimation result are obtained. The estimation result referred to here is, for example, a bounding box that is determined by the model for the object detection task by identifying a region that is likely to be a detection target object in the input image. The feature map obtained as an intermediate output is, for example, a two-dimensional map in which large values are recorded for two-dimensional coordinates corresponding to the region that is likely to be the predetermined object in the estimation. Although the bounding box and the feature map are described as examples of the estimation result and the intermediate output, the estimation result and the intermediate output are not limited to these examples. After finishing the estimation processing, the model evaluation unit 102 proceeds to step S2003.

In step S2003, the model evaluation unit 102 calculates the degree of estimation reliability of the evaluation image used for the evaluation based on the feature map output as the intermediate output of the estimation. As an example of the method for calculating the degree of estimation reliability, the model for the object detection task detects a bounding box by identifying a region that is likely to be the predetermined object in an input image, and calculates the degree of estimation reliability such that the degree of estimation reliability is high if that region has a large value in a feature map, which is an intermediate output referred to in the detection, and the degree of estimation reliability is low if that region has a small value in the feature map. Although an example of the method for calculating the degree of estimation reliability is described, the method for calculating the degree of estimation reliability is not limited to this example. After calculating the degree of estimation reliability, the model evaluation unit 102 proceeds to step S2004.

In step S2004, the model evaluation unit 102 compares the estimation result of the evaluation image and the correct answer information, and makes determination on the estimation result by determining whether the detection in the evaluation image was success or failure based on a degree of similarity between the estimation result and the correct answer information. As an example of the method for making determination on the estimation result, prescribed thresholds are set in advance for a displacement amount of the center position of the bounding box in the estimation result and the correct answer information and a difference in the size of the bounding box between the estimation result and the correct answer information, for example, and if the displacement amount or the difference is larger than the threshold, it is determined that the degree of similarity is low and the detection was failure, and if the displacement amount and the difference are equal to or smaller than the thresholds, it is determined that the degree of similarity is high and the detection was success. Although an example of the method for making determination on the estimation result is described, the method for making determination on the estimation result is not limited to this example. After making determination on the estimation result, the model evaluation unit 102 generates an estimation determination result and proceeds to step S2005.

In step S2005, the model evaluation unit 102 determines whether or not the model has been evaluated with use of all evaluation images included in the common evaluation data. If it is determined that there is an evaluation image with which the model has not been evaluated, the model evaluation unit 102 proceeds to step S2001. On the other hand, if it is determined that the model has been evaluated with use of all the evaluation images, the model evaluation unit 102 ends the model evaluation processing.

Through the processing described above, the model evaluation unit 102 can obtain degrees of estimation reliability and estimation determination results of the learned model corresponding to all the evaluation images included in the common evaluation data.

In the present embodiment configured as described above, favorable images and unfavorable images are displayed together with model information of learned models in association with the model information. Therefore, the present embodiment enables the user to select a learned model suitable for an intended use by assisting the user of the learned model in selecting the learned model from an enormous number of learned models that are made open. In particular, the present embodiment displays favorable images and unfavorable images, and therefore, it is possible to provide an environment that enables even a user who is not familiar with learned models to visually select an appropriate learned model more easily compared with a case where correct answer ratios of learned models or the like are displayed.

In the present embodiment, both a favorable image and an unfavorable image are displayed together with model information, and accordingly, the user can compare the favorable image and the unfavorable image and intuitively understand processing targets that can be processed favorably by the learned model and processing targets that cannot be processed favorably by the learned model. More specifically, if only the favorable image 306 shown in FIG. 7 is displayed and the unfavorable image 309 is not displayed, it is difficult for the user to determine whether the model is good at detecting an automobile as the detection target (in this example, an automobile), or the model is good at detecting the detection target in a bright image, or the model is good at detecting a single detection target. However, the present embodiment displays the favorable image 306 and the unfavorable image 309, and accordingly, the user can intuitively understand that the learned model corresponding to the model information 303 is good at detecting a single detection target in an image.

In the present embodiment, learned models created through machine learning are evaluated by the server, and therefore, it is possible to assist selection by the user of the information processing device 11 of the client while reducing processing load of the client.

In the present embodiment, learned models are evaluated with use of the common evaluation data, and therefore, it is possible to suppress variations in the evaluation of the plurality of learned models.

### (Variation 1 of First Embodiment)

In step S1004 shown in FIG. 5, the determination unit 103 determines one or more favorable images and one or more unfavorable images included in the evaluation images based on the degrees of estimation reliability and the estimation determination results corresponding to all the evaluation images received from the model evaluation unit 102, but there is no limitation to this configuration. For example, a configuration is also possible in which the determination unit 103 obtains estimation results corresponding to all the evaluation images from the model evaluation unit 102. Then, the determination unit 103 calculates degrees of similarity by comparing the estimation results and correct answer information of all the evaluation images included in the common evaluation data, and determines one or more favorable images in descending order of the degrees of similarity and determines one or more unfavorable images in ascending order of the degrees of similarity. Note that the degrees of similarity may be calculated in the object detection task based on, for example, ratios indicating a displacement amount of the center position of the bounding box in the estimation results and the correct answer information and a difference in the size of the bounding box between the estimation results and the correct answer information. Although an example of the method for calculating the degrees of similarity is described, the method for determining favorable images and unfavorable images is not limited to this example.

### Second Embodiment

An information processing system according to a second embodiment assists a user in selecting a learned model created through machine learning by displaying a list of model information managed in association with target identification information that is selected in a terminal of a client out of one type of identification information managed in database information, such as favorable images, unfavorable images, and image capturing information, whose list is displayed in the terminal of the client. The following describes a case where a task handled in the present embodiment is an object detection task that is performed by inputting images. However, the type of task that can be handled in the present embodiment is not limited to this example. The information processing system according to the second embodiment has a hardware configuration substantially the same as the configuration example in the first embodiment shown in FIGS. 1 and 2.

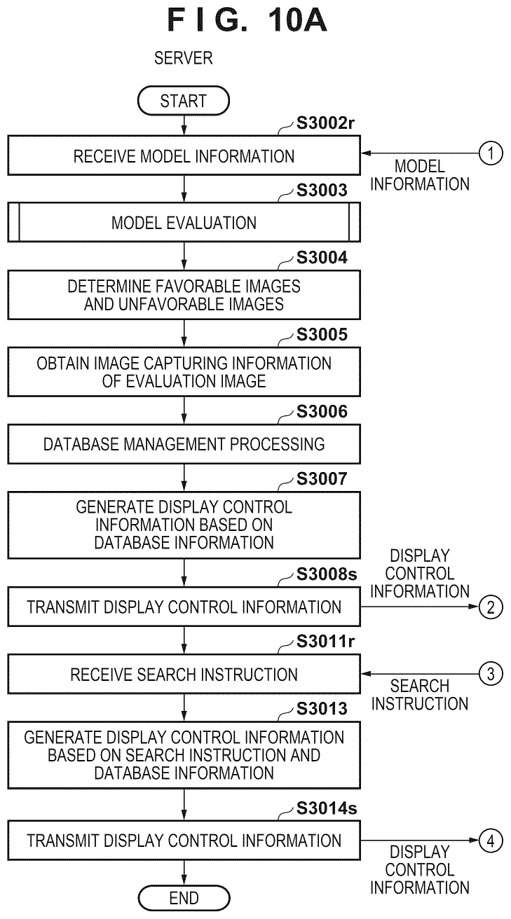

FIG. 9 is a block diagram showing a configuration example of the information processing system according to the second embodiment. An information processing device 40 of a server includes a server reception unit 401, a model evaluation unit 402, a determination unit 403, a management unit 404, a data holding unit 405, a generating unit 406, a server transmission unit 407, and an image capturing information obtaining unit 408. An information processing device 41 of a client includes a model information obtaining unit 411, a client transmission unit 412, a client reception unit 413, a display unit 414, and an instruction accepting unit 415.

Out of the functional units of the information processing system according to the second embodiment, descriptions of functional units that are the same as those in the configuration example of the first embodiment shown in FIG. 3 will be omitted, and the following describes the server reception unit 401, the management unit 404, the data holding unit 405, the generating unit 406, the image capturing information obtaining unit 408, and the instruction accepting unit 415 whose functions differ from those in the first embodiment.

The server reception unit 401 receives information from the client transmission unit 412 of the information processing device 41 of the client via a network. The server reception unit 401 receives, for example, model information and user instruction information. The server reception unit 401 receives data that has been converted into a suitable format before being transmitted. The server reception unit 401 converts the received data into a format that is suitable for use by a unit to which the data is output, and then outputs the data. The server reception unit 401 outputs the model information subjected to the data conversion to the model evaluation unit 402 and the management unit 404, and outputs the user instruction information subjected to the data conversion to the generating unit 406.

The management unit 404 receives the model information from the server reception unit 401, receives favorable images and unfavorable images from the determination unit 403, and receives image capturing information of all evaluation images held by the data holding unit 405. The management unit 404 generates database information for managing the favorable images, the unfavorable images, and the image capturing information in association with the model information, and updates the database information. The management unit 404 outputs the model information, the favorable images, and the unfavorable images to the data holding unit 405 so that data included in the database information will be held as entities. The management unit 404 outputs the managed database information to the generating unit 406.

The data holding unit 405 receives the model information, the favorable images, and the unfavorable images from the management unit 404, receives the image capturing information from the image capturing information obtaining unit 408, and holds the received information and images based on the database information. The information and data of the images and the like held by the data holding unit 405 are used or deleted via the management unit 404 in the information processing device 40 of the server.

The generating unit 406 generates display control information for displaying a list of favorable images for letting the user select a favorable image. The generating unit 406 generates display control information for displaying a list of model information associated with the favorable image selected by the user. Display of these lists will be described later. The generating unit 406 outputs the generated display control information to the server transmission unit 407.

The image capturing information obtaining unit 408 obtains image capturing information recorded in all evaluation images held by the data holding unit 405. Note that the image capturing information obtaining unit 408 may also obtain image capturing information from an imaging device such as a digital camera that captured the evaluation images. The image capturing information obtaining unit 408 outputs the image capturing information corresponding to all the evaluation images to the data holding unit 405 so that the image capturing information will be held as entities of data. The image capturing information indicates, for example, the type of camera, the type of lens, and an image capturing mode used to capture the corresponding image. However, the image capturing information obtained by the image capturing information obtaining unit 408 is not limited to this example, and may also be any information relating to image capturing.

The instruction accepting unit 415 accepts instruction information from the user in the information processing device 41 of the client. The accepted instruction information is a model information search instruction to search for model information based on identification information, such as a favorable image, associated with the model information and an instruction to end display of a list of favorable images or a list of model information. The instruction accepting unit 415 outputs the accepted model information search instruction and the accepted instruction to end display of a list to the client transmission unit 412.

Next, the following describes a processing procedure according to the present embodiment. In the following description, each step is denoted by a step number following S. In order to clarify differences from the processing in the first embodiment shown in FIG. 5, corresponding steps are described for processing that is the same as the processing described with reference to FIG. 5, and descriptions thereof are omitted.

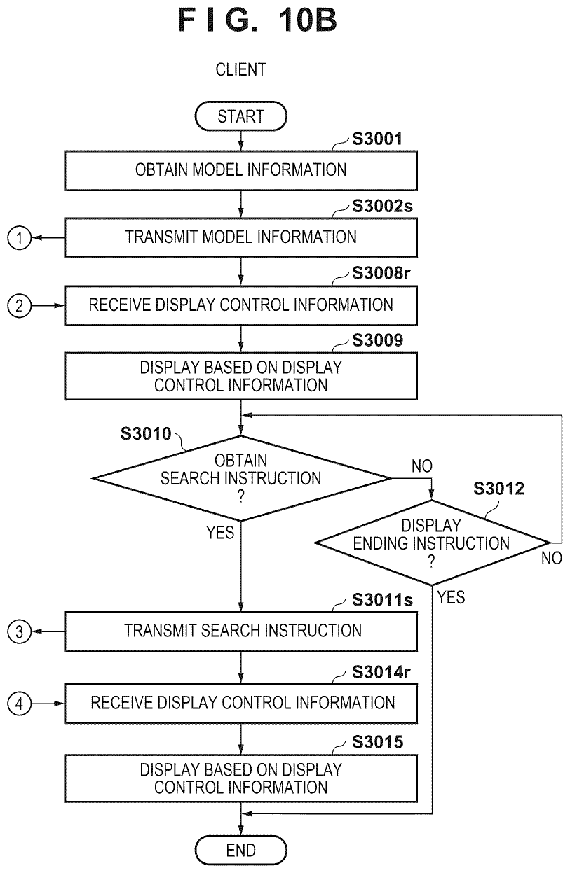

FIGS. 10A and 10B shows a flowchart of a procedure of display processing for displaying a list of model information associated with a favorable image that is a search instruction target in database information, which processing is performed by the information processing system including the information processing device 41 of the client and the information processing device 40 of the server. The processing shown in the flowchart of FIGS. 10A and 10B starts in response to model information that is a processing target being input, for example. However, the information processing system does not necessarily have to perform all steps shown in this flowchart.

As preparation for executing the processing shown in the flowchart, the information processing device 41 of the client initializes the system. For example, the CPU 1111 reads a program from the ROM 1112 or the hard disk 1116 and makes the information processing device 41 ready to operate. In the information processing device 40 of the server, the CPU 1101 reads a program from the ROM 1102 and makes the information processing device 40 ready to operate. As a result, the information processing device 41 of the client and the information processing device 40 of the server enter a state where the information processing devices can communicate with each other using the client transmission unit 412, the server reception unit 401, the server transmission unit 407, and the client reception unit 413.

Processing performed in steps S3001, S3002, S3003, and S3004 is the same as the processing performed in steps S1001, S1002, S1003, and S1004.

In step S3005, the image capturing information obtaining unit 408 obtains image capturing information recorded in all evaluation images included in common evaluation data held by the data holding unit 405. The image capturing information includes, for example, the types of cameras, the types of lenses, and information of image capturing modes used to capture the respective images. The image capturing information obtaining unit 408 outputs the image capturing information corresponding to all the evaluation images to the data holding unit 405 so that the image capturing information will be held as entities of data, and the processing proceeds to step S3006.

In step S3006, the management unit 404 executes database management processing. For example, the management unit 404 receives model information from the server reception unit 401, receives one or more favorable images and one or more unfavorable images from the determination unit 403, and receives the image capturing information corresponding to all the evaluation images held by the data holding unit 405. The management unit 404 generates or updates database information for managing the model information in association with the favorable images, the unfavorable images, and the image capturing information. The management unit 404 generates or updates database information of image capturing information for managing the evaluation images in association with the image capturing information. The management unit 404 outputs entities of the model information, the favorable images, and the unfavorable images to the data holding unit 405 so that the model information, the favorable images, and the unfavorable images will be held based on the database information. The management unit 404 outputs the managed database information to the generating unit 406.

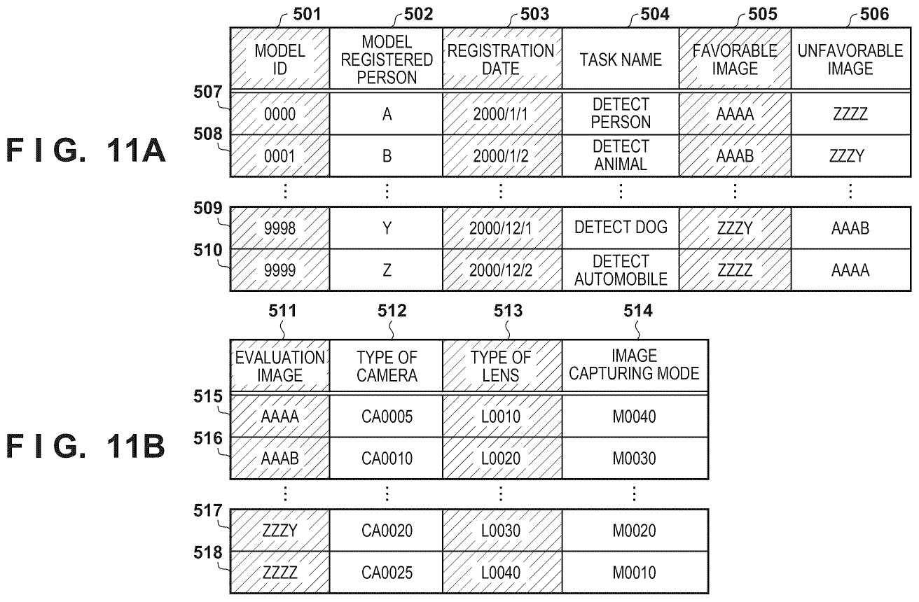

FIG. 11 shows an example of the database information generated by the management unit 404. FIG. 11A shows an example of the database information for managing favorable images and unfavorable images in association with model information. The following describes the database information with reference to FIG. 11A.

Model ID 501 is identification information for identifying a registered model. The name of a user who input and registered the model in the model information obtaining unit 411 is held as a model registered person 502. The date on which model information was input and registered in the model information obtaining unit 411 is held as a registration date 503. The name or type of task for which the model input to the model information obtaining unit 411 is used is held as a task name 504.

File names of favorable images determined in descending order of the detection accuracy from one or more favorable images received from the determination unit 403 are held as favorable images 505. Although the file name of a favorable image corresponding to the highest detection accuracy is held as the favorable image 505 in this example, there is no limitation on the number of file names of images to be held, and the number of file names is not limited to that in this example.

File names of unfavorable images determined in ascending order of the detection accuracy from one or more unfavorable images received from the determination unit 403 are held as unfavorable images 506. Although the file name of an unfavorable image corresponding to the lowest detection accuracy is held as the unfavorable image 506 in this example, there is no limitation on the number of file names of images to be held, and the number of file names is not limited to that in this example.

Model data 507 to 510 are examples of data relating to models managed in the database information. The model data 507 to 510 each include the model ID 501 and the data from the model registered person 502 to the unfavorable image 506, which are associated with the model ID 501.

FIG. 11B shows an example of the database information of image capturing information. The following describes the database information of image capturing information with reference to FIG. 11B.

The file name of an evaluation image included in the common evaluation data is held as an evaluation image 511. The type of camera used to capture the evaluation image is held as a camera type 512. The type of lens used to capture the evaluation image is held as a lens type 513. A mode set to capture the evaluation image is held as an image capturing mode 514.

Image capturing information 515 to 518 is an example of image capturing information managed in the database information of image capturing information. The image capturing information 515 to 518 each includes the evaluation image 511 and the data from the camera type 512 to the image capturing mode 514, which are associated with the evaluation image 511. Note that the image capturing information may also be associated with at least one of a favorable image or an unfavorable image in the database information of image capturing information.

In step S3007, the generating unit 406 obtains data such as image data that is necessary for display by the display unit 414 based on the database information received from the management unit 404, and generates display control information for displaying a list of favorable images. The generating unit 406 obtains, for example, a plurality of favorable images managed in the database information by the management unit 404 and held by the data holding unit 405. The generating unit 406 generates display control information regarding display contents and display settings including display positions of the obtained favorable images, a window size, and a display text, for example. However, the data obtained by the generating unit 406 and the display control information generated by the generating unit 406 are not limited to these examples, and may also be any information that can be managed in the database information. The generating unit 406 outputs the obtained data such as the favorable images (hereinafter referred to as the “obtained data”) and the generated display control information to the server transmission unit 407, and the processing proceeds to step S3008s.

In step S3008s, the server transmission unit 407 performs data conversion on the obtained data and the display control information based on the database information, and then transmits the obtained data and the display control information to the client reception unit 413 of the information processing device 10.

In step S3008r, the client reception unit 413 receives the display control information. The client reception unit 413 performs data conversion on the received display control information, and then outputs the display control information to the display unit 414.

In step S3009, the display unit 414 causes the display device 1114 to display a list of the plurality of favorable images based on the obtained data and the display control information received from the client reception unit 413.

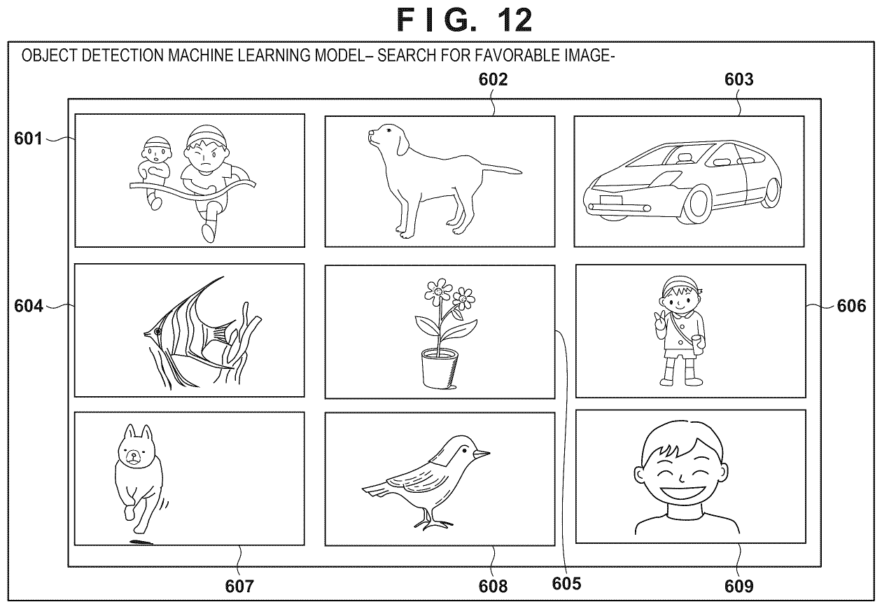

FIG. 12 shows an example of the list of the favorable images displayed by the display unit 414 with use of the display control information. The following describes the displayed list of the favorable images with reference to FIG. 12.

Favorable images 601 to 609 displayed in the list are favorable images included in the database information managed by the management unit 404 of the information processing device 40 of the server.

Although nine favorable images are displayed in the list in this example, there is no limitation on display control regarding the images displayed in the list, the number of images, display positions of the images, etc., and the displayed list is not limited to this example.

In step S3010, the instruction accepting unit 415 determines whether or not a model information search instruction has been obtained. For example, the instruction accepting unit 415 determines whether or not a model information search instruction has been obtained from the user based on whether or not the user has selected a favorable image included in the list of the favorable images displayed by the display unit 414. More specifically, the user touches a touch panel, which is an example of the input device 1113, while the list of the favorable images 601 to 609 is displayed. The instruction accepting unit 415 detects, for example, coordinates of the position touched by the user, and determines whether or not a favorable image is displayed at the coordinates. If a favorable image is displayed at the coordinates, the instruction accepting unit 415 determines that the favorable image has been selected and a search instruction has been obtained. This search instruction is an instruction to search for one or more pieces of model information associated with the favorable image selected by the user in the database information, and to display a list of the model information as a search result. The search instruction accepted by the instruction accepting unit 415 is not limited to this instruction, and may also be any instruction information such as an instruction to search for model information with use of different identification information (e.g., an unfavorable image or image capturing information) associated with the model information. If the instruction accepting unit 415 has obtained a search instruction, the instruction accepting unit outputs the search instruction to the client transmission unit 412, and the processing proceeds to step S3011s. On the other hand, if the instruction accepting unit 415 has not obtained a search instruction, the processing proceeds to step S3012.

In step S3011s, the client transmission unit 412 performs data conversion on the search instruction including information of the favorable image selected by the user and the like, and then transmits the search instruction to the server reception unit 401 of the server.

In step S3012, the instruction accepting unit 415 determines whether or not a display ending instruction has been accepted from the user. Upon determining that the display ending instruction has not been accepted, the instruction accepting unit 415 repeats step S3010. On the other hand, upon determining that the display ending instruction has been accepted, the instruction accepting unit 415 stops display by the display unit 414 and ends the processing.

In step S3011r, the server reception unit 401 performs data conversion on the received search instruction, and then outputs the search instruction to the generating unit 406.

In step S3013, the generating unit 406 obtains data such as the favorable image that is necessary for display by the display unit 414 based on the search instruction received via the server reception unit 401 and the database information received from the management unit 404, and generates display control information. The display control information generated by the generating unit 406 is, for example, control information regarding display contents and display settings including a plurality of pieces of model information associated with the favorable image that is selected by the user and included in the search instruction, display positions of the favorable image and the model information, a window size, and a display text indicating contents of the model information and the like. The generating unit 406 outputs the generated display control information to the server transmission unit 407, and the processing proceeds to step S3014s.

In step S3014s, the server transmission unit 407 performs data conversion on the received display control information, and then transmits the display control information to the client reception unit 413 of the client.

In step S3014r, the client reception unit 413 performs data conversion on the display control information received from the server transmission unit 407, and then outputs the display control information to the display unit 414, and the processing proceeds to step S3015.

In step S3015, the display unit 414 causes the display device 1114 to display a list of model information with use of the display control information generated based on the search instruction from the user and the database information.

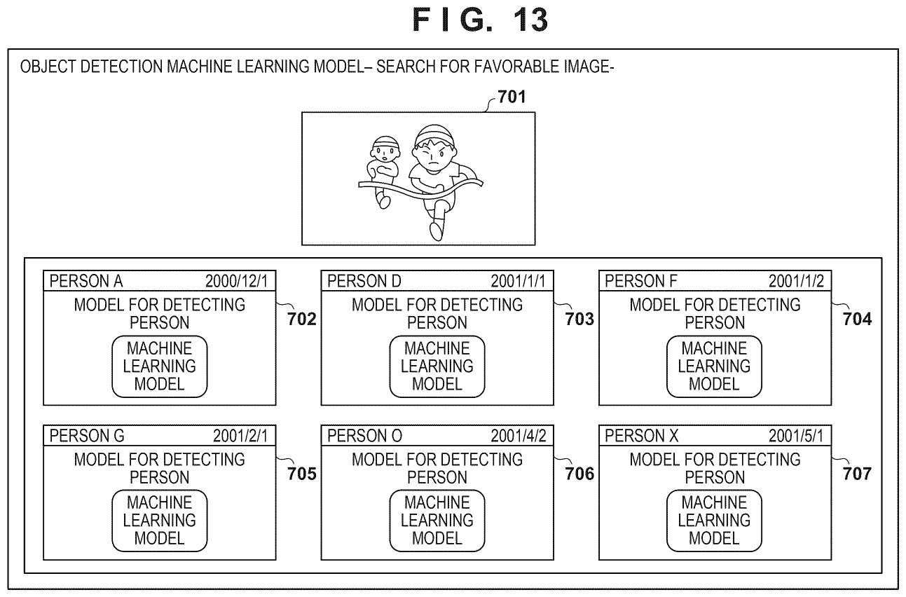

FIG. 13 shows an example of the list of model information displayed by the display unit 414 with use of the display control information. The following describes the displayed list with reference to FIG. 13.

A favorable image 701 is the favorable image corresponding to the search instruction accepted from the user by the instruction accepting unit 415. Model information 702 to 707 displayed in the list is model information associated with the favorable image corresponding to the search instruction in the database information. Although one favorable image and six pieces of model information associated with the favorable image are displayed in the list in this example, there is no limitation on display control regarding the displayed image, the number of pieces of model information, display positions of the image and the model information, etc., and the form of the displayed list is not limited to this example.

According to the present embodiment configured as described above, it is possible to assist the user in selecting a learned model by displaying a list of model information managed in association with target identification information that is selected in the terminal of the client out of one type of identification information managed in the database information, such as favorable images, unfavorable images, or image capturing information, whose list is displayed in the terminal of the client.

### (Variation 1 of Second Embodiment)

In steps S3009 and S3015 shown in FIG. 10B, a list of favorable images managed in the database information is displayed by the display unit 414, and a list of model information associated with a favorable image is displayed based on a search instruction accepted by the instruction accepting unit 415, but the displayed images are not limited to favorable images. For example, a configuration is also possible in which a list of unfavorable images managed in the database information is displayed, and based on a search instruction indicating an unfavorable image and accepted by the instruction accepting unit 415, the generating unit 406 generates display control information for displaying a list of model information with which the unfavorable image indicated by the search instruction is associated as a favorable image.

In this case, it is possible to search for models that are good at detecting scenes of which detection has failed, and accordingly, improvement in the performance of search of model information can be expected.

### (Variation 2 of Second Embodiment)

In steps S3009 and S3015 shown in FIG. 10B, a list of favorable images managed in the database information is displayed by the display unit 414, and a list of model information associated with a favorable image is displayed based on a search instruction accepted by the instruction accepting unit 415, but the displayed images are not limited to favorable images. For example, a configuration is also possible in which a list of model information managed in the database information is displayed, and based on a search instruction accepted by the instruction accepting unit 415, the generating unit 406 generates display control information for displaying favorable images and unfavorable images managed in association with model information indicated by the search instruction.

In this case, it is possible to easily check the favorable images and the unfavorable images indicating features of the model information based on the instruction from the user, and accordingly, improvement in the performance of search of model information can be expected.

### (Variation 3 of Second Embodiment)

In steps S3009 and S3015 shown in FIG. 10B, a list of favorable images managed in the database information is displayed by the display unit 414, and a list of model information associated with a favorable image is displayed based on a search instruction accepted by the instruction accepting unit 415, but there is no limitation to this example. For example, a configuration is also possible in which the display unit 414 displays a list of image capturing information managed in the database information, and based on a search instruction accepted by the instruction accepting unit 415, the display unit 414 displays a list of model information managed in association with image capturing information indicated by the search instruction. For example, the generating unit 406 may generate display control information for displaying a list of model information for which an evaluation image associated with the image capturing information indicated by the search instruction is a favorable image.

In this case, it is possible to search for model information suitable for an intended use according to an image capturing device and an image capturing mode that are to be used, and accordingly, improvement in the performance of search of model information can be expected.

### OTHER EMBODIMENTS

In the first and second embodiments, an information processing system including an information processing device of a server and information processing devices of one or more clients that can communicate with the information processing device of the server is described, but the information processing system is not limited to this example. For example, an embodiment is also possible in which the information processing system obtains model information, manages databases, displays model information, performs search, and displays lists in a single information processing device. Alternatively, the information processing system may also be realized by three or more information processing devices.

In the above embodiments, the management unit 104 or 404 manages database information in which both favorable images and unfavorable images are associated with model information, but the management unit may also manage database information in which at least one of favorable images or unfavorable images are associated with model information. For example, if the management unit manages only favorable images in database information, the generating unit can display favorable images together with a list of model information. With this configuration, the information processing system can present favorable images for respective learned models to the user, and thus assist the user in selecting a learned model. If the management unit manages only unfavorable images in database information, the generating unit can display unfavorable images together with a list of model information. With this configuration, the information processing system can present unfavorable images for respective learned models to the user, and thus prevent the user from selecting an inappropriate learned model.

In the above embodiments, learned models created through machine learning and configured to process images are described, but the processing targets are not limited to images. For example, the above embodiments may also be applied to learned models created through machine learning and configured to process sound, text data, or the like. In the case where the above embodiments are applied to machine learning models configured to process sound, the determination unit may determine a favorable sound as a favorable item and an unfavorable sound as an unfavorable item based on a favorable frequency, a favorable sound volume expressed by dB (decibel), or the like, the generating unit may generate display control information for displaying a list of text information or the like indicating the frequency or the sound volume, and the list may be displayed for the user. Furthermore, the information processing system may also output an example of sound selected by the user in the displayed list of information relating to sound.

In the above embodiments, the generating unit displays a list of model information, but the displayed form of model information is not limited to a list. For example, a configuration is also possible in which the generating unit generates display control information such that a piece of model information and a favorable image and an unfavorable image associated with the model information are displayed as a set on a screen, and the displayed set of the model information, the favorable image, and the unfavorable image is switched sequentially in response to a switching instruction from the user.

In the above embodiments, the generating unit generates display control information for displaying favorable images and unfavorable images as they are as information regarding the favorable images and the unfavorable images, but the display control information is not limited to this example. For example, the generating unit may also generate a text indicating information regarding the favorable images and the unfavorable images, rather than generating control information for displaying the favorable images and the unfavorable image as they are. For example, the generating unit may also generate display control information for displaying “bright image” as information regarding the favorable images and “dark image” as information regarding the unfavorable images.

In the above embodiments, no description is given to what happens in response to a learned model being selected by the user, but a configuration is also possible in which the display unit displays a warning message or the like if an image that is intended by the user to be processed by the learned model is similar to unfavorable images of the learned model selected by the user.

In the above embodiments, a learned model is selected in the state where learned models and favorable images are displayed, but the display method for the selection of a learned model is not limited to this example. For example, a configuration is also possible in which a learned model is selected by the user in a state where a plurality of learned models are displayed by the display unit, and thereafter at least one of a favorable image or an unfavorable image associated with the learned model is displayed to confirm whether or not the user wants to use the learned model.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074038, filed Apr. 30, 2024, which is hereby incorporated by reference herein in its entirety.

What is claimed is:

1. An information processing device comprising:
a management unit configured to manage database information in which model information regarding a learned model is associated with at least one of a favorable item and an unfavorable item among processing targets processed by the learned model, the learned model being good at processing the favorable item and not good at processing the unfavorable item; and
a generating unit configured to generate display control information for displaying the model information and information regarding at least one of the favorable item and the unfavorable item associated with the model information based on the database information.

2. The information processing device according to claim 1, further comprising:
an evaluation unit configured to obtain the model information and generate an evaluation result by evaluating the learned model.

3. The information processing device according to claim 2,
wherein the evaluation unit generates the evaluation result by evaluating the learned model with use of common evaluation data including common evaluation targets.

4. The information processing device according to claim 2, further comprising:
a determination unit configured to determine the favorable item and the unfavorable item based on a degree of estimation reliability indicated by the evaluation result and an estimation determination result that is a result of determination on an estimation result.

5. The information processing device according to claim 2, further comprising:
a determination unit configured to determine the favorable item and the unfavorable item based on a degree of similarity obtained by comparing an estimation result indicated by the evaluation result and correct answer information.

6. The information processing device according to claim 1,
wherein the processing targets are captured images, and
the management unit manages database information of image capturing information in which image capturing information regarding capturing of the images is associated with at least any of the model information, a favorable image as the favorable item, an unfavorable image as the unfavorable item, and the captured images.

7. The information processing device according to claim 1,
wherein the generating unit generates display control information for displaying at least one of the favorable item and the unfavorable item, and a list of the model information.

8. The information processing device according to claim 1,
wherein the management unit manages identification information in the database information, the identification information being information associated with the model information and relating to the processing targets, and
the generating unit generates display control information for displaying at least some piece of the identification information and a list of the model information.

9. The information processing device according to claim 1,
wherein the management unit searches for the model information associated with the favorable item that is selected by a user, and
the generating unit generates display control information for displaying a list of the searched model information together with the favorable item.

10. The information processing device according to claim 1,
wherein the management unit searches for model information with which the unfavorable item that is selected by a user is associated as a favorable item, and
the generating unit generates display control information for displaying a list of the searched model information together with the favorable item.

11. The information processing device according to claim 1,
wherein the management unit searches for the model information based on identification information selected by a user out of pieces of identification information associated with the model information and relating to the processing targets, and
the generating unit generates display control information for displaying a list of the searched model information together with the selected identification information.

12. The information processing device according to claim 1,
wherein the generating unit generates display control information for displaying a list of a plurality of pieces of model information and displaying, and the favorable item and the unfavorable item associated with each piece of the model information.

13. An information processing system comprising:
the information processing device according to claim 1;
a display unit configured to cause a display device to display at least one of the favorable item and the unfavorable item, and a list of the model information based on the display control information; and
a model information obtaining unit configured to obtain the model information.

14. An information processing method comprising:
managing database information in which model information regarding a learned model is associated with at least one of a favorable item and an unfavorable item among processing targets processed by the learned model, the learned model being good at processing the favorable item and not good at processing the unfavorable item; and
generating display control information for displaying the model information and information regarding at least one of the favorable item and the unfavorable item associated with the model information based on the database information.

15. A non-transitory computer-readable storage medium storing a computer program that, when read and executed by a computer, causes the computer to function as:
a management unit configured to manage database information in which model information regarding a learned model is associated with at least one of a favorable item and an unfavorable item among processing targets processed by the learned model, the learned model being good at processing the favorable item and not good at processing the unfavorable item; and
a generating unit configured to generate display control information for displaying the model information and information regarding at least one of the favorable item and the unfavorable item associated with the model information based on the database information.
